(19) United States
(12) Patent Application Publication
(10) Pub. No.: US 2025/0023674 A1
(43) Pub. Date: Jan. 16, 2025

(54) RESOURCE SELECTION OF SIDELINK CA

(71) Applicant: Lenovo (Beijing) Limited, Beijing (CN)

(72) Inventors: Zhennian Sun, Beijing (CN); Xiaodong Yu, Beijing (CN); Haipeng Lei, Beijing (CN); Xin Guo, Beijing (CN)

(73) Assignee: Lenovo (Beijing) Limited, Beijing (CN)

(21) Appl. No.: 18/711,515

(22) PCT Filed: Nov. 19, 2021
(86) PCT No.: PCT/CN2021/131787

§ 371 Date: May 17, 2024

(51) Int. Cl. H04L 5/00; H04W 72/02

(52) U.S. Cl. CPC H04L 5/001; H04L 5/0055; H04W 72/02

(57) ABSTRACT

Methods and apparatuses for resource selection of sidelink CA are disclosed. A method of a user equipment (UE) comprises: excluding, from a candidate resource set for a first carrier, resources based on reception of Physical Sidelink Feedback Channel (PSFCH) resource(s) on the first carrier or on a second carrier and transmission of selected resource(s) on the second carrier; and selecting, from the candidate resource set in which the resources are excluded at least based on reception of PSFCH resource(s) on the first carrier or on the second carrier and transmission of selected resource(s) on the second carrier, resources on the first carrier for transmission.

### FIELD

The subject matter disclosed herein generally relates to wireless communications, and more particularly relates to methods and apparatuses for resource selection of sidelink carrier aggregation (CA).

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Power management Maximum Power Reduction (P-MPR), maximum permissible exposure (MPE), Power Headroom Report (PHR), Medium Access Control (MAC), MAC control element (MAC CE), Physical Sidelink Feedback Channel (PSFCH), Carrier aggregation (CA), Automatic Repeat-reQuest (ARQ), Hybrid ARQ (HARQ), Sidelink Control Information (SCI), vehicle to everything (V2X), Demodulation Reference Signal (DMRS), Physical Sidelink Control Channel (PSCCH), Physical Sidelink Shared Channel (PSSCH), Automatic Gain Control (AGC), component carrier (CC).

Sidelink means communication directly between two UEs (e.g. UE-A and UE-B), without the need to be via a base station (e.g. gNB). In each transmission, one UE (one of UE-A and UE-B) transmits signal or data, which can be referred to as Tx UE, while the other UE (the other of UE-A and UE-B) receives signal or data, which can be referred to as Rx UE. In NR sidelink, different numerologies, e.g. different sub-carrier spacings of 15 kHz, 30 kHz, 60 kHz and 120 kHz, are supported.

Carrier aggregation (CA) means that a communication can be made via multiple carriers that can be aggregated together. The multiple carriers can be in the same band, i.e. intra-band CA, or in different bands, i.e. inter-band CA. In NR sidelink CA, sidelink HARQ feedback is supported. The sidelink HARQ feedback is transmitted in PSFCH. In addition, in NR Release 17, it is agreed that PSFCH format 0 can be used to convey the presence of expected or potential resource conflict on reserved resource(s) indicated by UE-B's SCI (which is referred to as “reserved resource conflict indicator”). In particular, UE-B transmits an SCI in a first resource to UE-A to indicate that a reserved resource will be transmitted in a second resource. In a time occasion between the first resource and the second resource, a PSFCH indicating the reserved resource conflict indicator can be received by UE-B. In one implementation, the PSFCH indicating the reserved resource conflict indicator is associated with the first resource carrying the SCI. In an alternative implementation, the PSFCH indicating the reserved resource conflict indicator is associated with the second resource (i.e. the reserved resource reserved by the SCI carried in the first resource). As a whole, PSFCH can be used to receive sidelink HARQ feedback or reserved resource conflict indicator.

The slot format for NR V2X may include or not include PSFCH. It means that, although PSFCH is supported in NR Release 17, it is not necessary that the PSFCH has to be included. One example of the slot format that does not include PSFCH is shown in FIG. 1(a). It can be seen from FIG. 1(a) that a slot of 14 symbols includes PSCCH of 2 symbols, DMRS (i.e. PSSCH-DMRS) of 2 symbols, PSSCH of 10 symbols (two symbols are shared by PSCCH and PSSCH), and AGC of 1 symbol and a guard period of 1 symbol, where no symbol is for PSFCH. Another example of the slot format that includes PSFCH is shown in FIG. 1(b). It can be seen from FIG. 1(b) that a slot of 14 symbols includes PSCCH of 3 symbols, DMRS (i.e. PSSCH-DMRS) of 3 symbols, PSSCH of 6 symbols (in which one symbol is shared by DMRS and PSCCH and two symbols are shared by PSCCH and PSSCH), AGC of 1 symbol, and AGC of PSFCH of 1 symbol, PSFCH of 1 symbol, and two guard symbols.

In half-duplex mode, the UE cannot perform transmission and reception at the same time. It means that the UE only performs transmission or reception at a time occasion. In consideration of support of PSFCH in NR Release 17, for intra-band sidelink CA, it is generally not preferable that, two carriers are aggregated for a resource (such as a slot or several symbols), in one carrier of which the resource is used for reception of PSFCH and in the other carrier of which the resource is used for transmission of PSSCH or PSCCH.

This disclosure targets solutions to avoid half-duplex issue during the resource selection procedure.

### BRIEF SUMMARY

Methods and apparatuses for resource selection of sidelink CA are disclosed.

In one embodiment, a method of a UE comprises excluding, from a candidate resource set for a first carrier, resources based on reception of Physical Sidelink Feedback Channel (PSFCH) resource(s) on the first carrier or on a second carrier and transmission of selected resource(s) on the second carrier; and selecting, from the candidate resource set in which the resources are excluded at least based on reception of PSFCH resource(s) on the first carrier or on the second carrier and transmission of selected resource(s) on the second carrier, resources on the first carrier for transmission.

In one embodiment, if a resource on the first carrier overlaps in time domain with reception of the PSFCH resource associated with a selected resource on the second carrier, the resource is excluded from the candidate resource set for the first carrier. In particular, f any of the following criteria is met, the resource(s) are excluded from the candidate resource set for the first carrier if the resource on the first carrier overlaps in time domain with reception of the PSFCH resource associated with a selected resource on the second carrier: (a) the priority of the transmission on the first carrier is lower than each of the priorities of all transmissions associated with the PSFCH on the second carrier, (b) the priority of the transmission on the first carrier is lower than a first configured priority threshold, and (c) each of the priorities of all transmissions associated with the PSFCH on the second carrier is higher than a second configured priority threshold.

In another embodiment, if the PSFCH resource associated with a resource on the first carrier overlaps in time domain with a selected resource on the second carrier, the resource is excluded from the candidate resource set for the first carrier. In particular, if any of the following criteria is met, the resource(s) are excluded from the candidate resource set for the first carrier if the PSFCH resource associated with the resource on the first carrier overlaps in time domain with a selected resource on the second carrier: (a) the priority of the transmission associated with the PSFCH on the first carrier is lower than each of the priorities of all transmissions on the second carrier, (b) the priority of the transmission associated with the PSFCH on the first carrier is lower than a third configured priority threshold, and (c) each of the priorities of all transmissions associated with the PSFCH on the second carrier is higher than a fourth configured priority threshold.

In some embodiment, the PSFCH resource may be used for Hybrid Automatic Repeat-reQuest (HARQ) feedback or resource conflict indicator.

In another embodiment, a UE comprises a processor and a transceiver, wherein the processor is configured to exclude, from a candidate resource set for a first carrier, resources based on reception of Physical Sidelink Feedback Channel (PSFCH) resource(s) on the first carrier or on a second carrier and transmission of selected resource(s) on the second carrier; and select, from the candidate resource set in which the resources are excluded at least based on reception of PSFCH resource(s) on the first carrier or on the second carrier and transmission of selected resource(s) on the second carrier, resources on the first carrier for transmission by the transceiver.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIGS. 1(a) and 1(b) illustrates two slot formats;

FIGS. 2(a), 2(b) and 2(c) illustrate three examples of the first embodiment;

FIGS. 3(a), 3(b) and 3(c) illustrate three examples of the second embodiment;

FIG. 4 illustrates an example of the fourth embodiment;

FIG. 5 is a schematic flow chart diagram illustrating an embodiment of a method; and

FIG. 6 is a schematic block diagram illustrating apparatuses according to one embodiment.

### DETAILED DESCRIPTION

As will be appreciated by one skilled in the art that certain aspects of the embodiments may be embodied as a system, apparatus, method, or program product.

Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

A UE is configured with a set of TX carriers for sidelink transmission. Several carriers can be aggregated. The UE performs per-carrier independent sensing and resource selection. Part of the configured carriers may be configured with PSFCHs for sidelink HARQ feedback or reserved resource conflict indicator, and part of configured carriers may be configured without PSFCHs. Same numerology (i.e. subcarrier spacing) or different numerologies may be configured for these carriers.

In the following description, a carrier may be referred to as a CC (component carrier).

According to a first embodiment, when the UE performs per-carrier independent resource selection for one carrier, the overlapping between transmission of the candidate resource and reception of the PSFCH(s) associated with already selected resources on other carrier(s) is considered.

The UE performs carrier resource selection in ascending order of priority value of each transmission. Each transmission of a resource (e.g. a slot or several symbols) is associated with a priority value, e.g. from 0 to 7. The priority value with lower value has higher priority. That is, the transmission of the resource with priority value 0 has the highest priority. The carrier resource selection is first performed for the transmission(s) of the resource(s) with priority value 0, and then performed for the transmission(s) of the resource(s) with priority value 1, and so on, i.e. in ascending order of the priority value.

For one carrier on which the UE performs resource selection for the sidelink transmission, the UE excludes the resources that are overlapped in time domain with the PSFCH resource(s) associated with already selected resources on the other carrier(s).

The resource that overlaps in time domain with the PSFCH resource(s) may be a slot or configured number of symbols (in one CC). Within the time domain of the resource (the slot or the configured number of symbols), if there is any PSFCH resource that would be received (in another CC) in time domain, the resource is determined as overlapping in time domain with the PSFCH resource. In other words, it is not necessary that the PSFCH resource is transmitted in the whole time length of the resource that is to be selected. Incidentally, the time length of the resource to be selected (e.g. the time length of the slot) depends on numerology (e.g. one of 15 kHz, 30 kHz, 60 kHz and 120 kHz), while the time length of the PSFCH resource may depend on the same numerology or a different numerology.

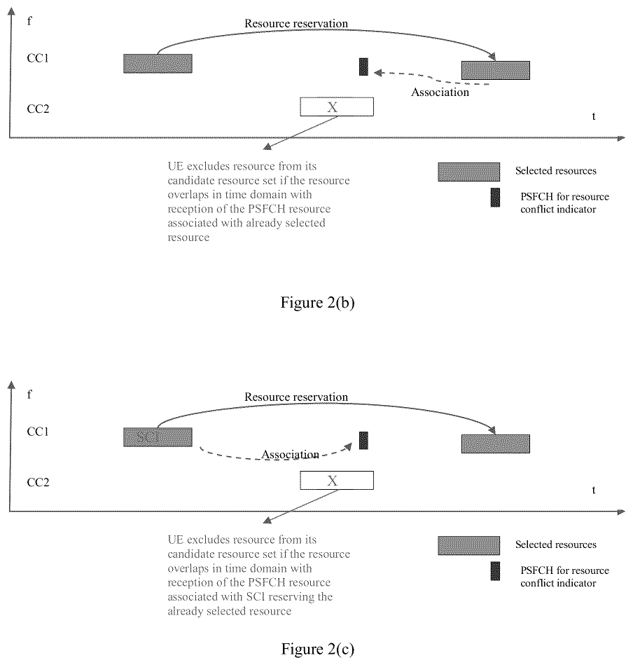

FIGS. 2(a), 2(b) and 2(c) are three examples of the first embodiment.

In FIG. 2(a), the UE is intended to receive the HARQ feedback on the PSFCH resource associated with the already selected resource. The HARQ feedback on the PSFCH resource being associated with the already selected resource means that the time occasion of the PSFCH resource is determined by the time occasion of transmission of the already selected resource. So, the resource (e.g. one slot) on one CC (e.g. CC2) that overlaps in time domain with the PSFCH resource (for HARQ feedback) associated with the already selected resource in another CC (e.g. CC1) is excluded from its candidate resource set and not being selected.

In FIG. 2(b), the UE is intended to receive the reserved resource conflict indicator on the PSFCH resource associated with the already selected resource. The reserved resource conflict indicator on the PSFCH resource being associated with the already selected resource means that the time occasion of the PSFCH resource is determined by the time occasion of transmission of the already selected resource. So, the resource (e.g. one slot) on one CC (e.g. CC2) that overlaps in time domain with the PSFCH resource (for the reserved resource conflict indicator) associated with the already selected resource in another CC (e.g. CC1) is excluded from its candidate resource set and not being selected.

In FIG. 2(c), the UE is intended to receive the reserved resource conflict indicator on the PSFCH resource associated with the transmission of SCI reserving the already selected resource. The reserved resource conflict indicator on the PSFCH resource being associated with the transmission of SCI means that the time occasion of the PSFCH resource is determined by the time occasion of transmission of the SCI. So, the resource (e.g. one slot) on one CC (e.g. CC2) that overlaps in time domain with the PSFCH resource (for the reserved resource conflict indicator) associated with the transmission of SCI reserving the already selected resource in another CC (e.g. CC1) is excluded from being selected. In addition, since the transmission of SCI reserves the already selected resource, it can be said that the resource (e.g. one slot) on one CC (e.g. CC2) that overlaps in time domain with the PSFCH resource (for the reserved resource conflict indicator) associated with the already selected resource in another CC (e.g. CC1) is excluded from its candidate resource set and not being selected.

The candidate resource set for a carrier may initially include all available resources on the carrier. In the examples shown in FIGS. 2(a), 2(b) and 2(c), if the resource is selected from the candidate resource set for a carrier (e.g. CC2), each of the resources on one CC (e.g. CC2) that overlaps in time domain with the PSFCH resource associated with the already selected resource in another CC (e.g. CC1) is excluded from the candidate resource set for the carrier (e.g. CC2).

Further, according to a variety of the first embodiment, only when a certain criterion is met, the UE excludes the resources on one CC that overlap in time domain with the PSFCH resource(s) associated with already selected resources on other CCs.

The certain criterion can be for example any one of the following (1) to (3):
(1) The priority of the transmission on CC2 (i.e. the carrier on which the resource is to be selected) is lower than each of the priorities of all transmissions associated with the overlapping PSFCH resource(s) on CC1 (i.e. the carrier on which the already selected resource(s) and the associated PSFCH resources are to be transmitted).
(2) The priority of the transmission on CC2 (i.e. the carrier on which the resource is to be selected) is lower than a first priority threshold, where the first priority threshold can be predetermined or configured.
(3) Each of the priorities of all transmissions associated with the overlapping PSFCH resource(s) on CC1 (i.e. the carrier on which the already selected resource(s) and the associated PSFCH resources are to be transmitted) is higher than a second priority threshold, where the second priority threshold can be predetermined or configured.

Incidentally, if none of the criteria (1) to (3) is met, the resources on one CC that are overlapped in time domain with the PSFCH resource(s) associated with already selected resources on other CCs may not be excluded. It may be up to the implementation of the UE to decide whether the resources on one CC that overlap in time domain with the PSFCH resource(s) associated with already selected resources on other CCs are excluded from the candidate resource set if the priority is equal to the priority threshold for the criteria (2) and (3).

According to the first embodiment, the candidate resources in one CC that overlap with the PSFCH resource(s) associated with the already selected resource in another CC are excluded from the candidate resource set for the one CC. Some other candidate resources may additionally be excluded from the candidate resource set for the one CC according to other criterion or criteria. For example, some other candidate resources may be excluded from the candidate resource set for the one CC in the per-carrier independent sensing procedure, or any other procedure(s). The order of excluding candidate resources from the candidate resource set for the one CC can be any order. It means that the exclusion of candidate resources from the candidate resource set for the one CC can be first performed in the per-carrier independent sensing procedure, or in any other procedure(s), and alternatively, the exclusion of candidate resources from the candidate resource set for the one CC can be first performed by considering the overlapping between transmission of the candidate resource and reception of the PSFCH(s) associated with already selected resources on other carrier(s). Accordingly, according to the first embodiment, the UE selects resources for transmission in sidelink CA from the candidate resource set in which at least the overlapped resources have been excluded.

According to a second embodiment, when the UE performs per-carrier independent resource selection for one carrier for a sidelink transmission associated with reception of PSFCH resource, the overlapping between reception of the PSFCH resource associated with candidate resources and transmission of the already selected resources on other carrier(s) is considered.

The UE performs carrier resource selection in ascending order of priority value of each transmission.

For one carrier which the UE performs resource selection for the sidelink transmission associated with reception of PSFCH resource, the UE excludes the resources if reception of the PSFCH resource(s) associated with the resources overlaps with the already selected resources on the other carrier(s).

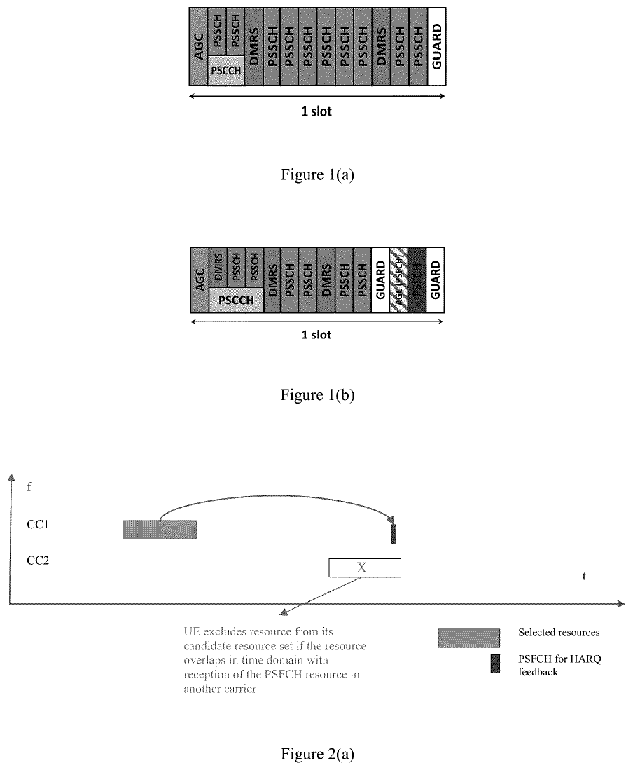

The reception of PSFCH resource associated with the sidelink transmission that overlaps in time domain with the already selected resources on the other carrier(s) may be in two symbols, or two symbols along with additional two guard symbols (e.g. with reference to FIG. 1(b)). If there is any already selected resource to be transmitted (on another CC) in the two symbols (or the two symbols and the two guard symbols), it is determined that the reception of associated PSFCH resource overlaps with the already selected resource.

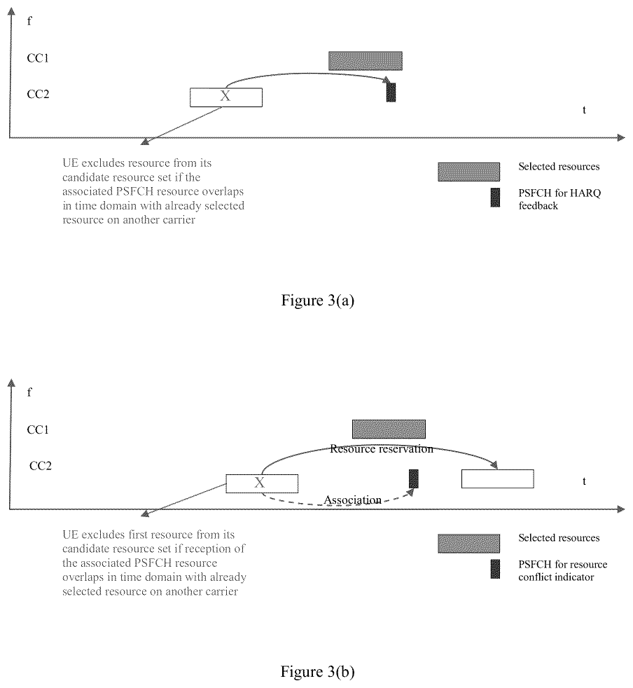

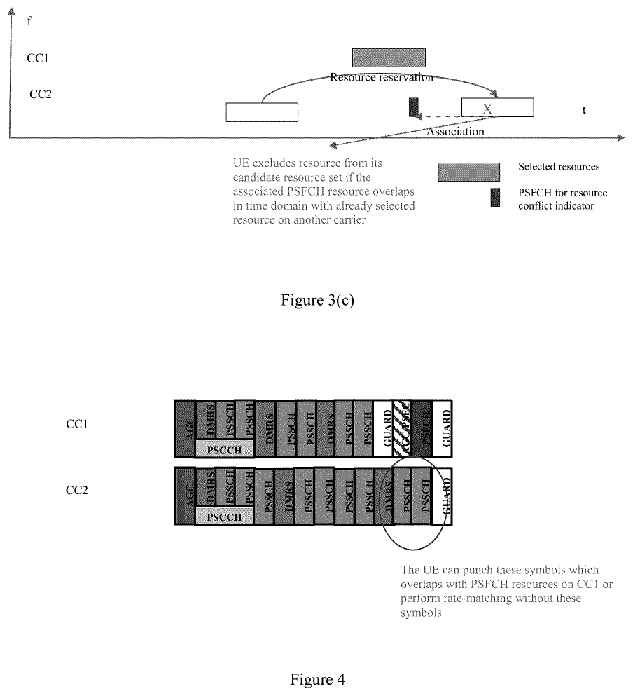

FIGS. 3(a), 3(b) and 3(c) are three examples of the second embodiment.

In FIG. 3(a), the UE performs the resource selection for a sidelink transmission with HARQ feedback enabled on CC2. The HARQ feedback is to be received in PSFCH resource associated with the sidelink transmission. For a candidate resource to be selected on CC2, if the reception of the PSFCH resource associated with the candidate resource overlaps with the already selected resource in another CC (e.g. CC1), the candidate resource is excluded from its candidate resource set (i.e. the candidate resource set for CC1) and not being selected.

In FIG. 3(b), the UE is intended to receive the reserved resource conflict indicator on a carrier (e.g. CC2), where an SCI transmitted in a first resource that is associated with the reserved resource conflict indicator reserves a second resource. The reserved resource conflict indicator is to be received in a PSFCH resource on the carrier (e.g. CC2). For the first resource, if the reception of the PSFCH resource associated with the first resource overlaps with the already selected resource in another CC (e.g. CC1), the first resource is excluded from its candidate resource set and not being selected.

In FIG. 3(c), the UE is intended to receive the reserved resource conflict indicator on a carrier (e.g. CC2), where an SCI transmitted in a first resource reserves a second resource that is associated with the reserved resource conflict indicator. The reserved resource conflict indicator is to be received in a PSFCH resource on the carrier (e.g. CC2). For the second resource, if the reception of the PSFCH resource associated with the second resource overlaps with the already selected resource in another CC (e.g. CC1), the second resource is excluded from its candidate resource set and not being selected.

In the examples shown in FIGS. 3(a), 3(b) and 3(c), if the resource is selected from a candidate resource set, the resource on one CC (e.g. CC2), the associated PSFCH resource of which overlaps in time domain with the already selected resource in another CC (e.g. CC1), may be excluded from the candidate resource set for the one CC (e.g. CC2).

Further, according to a variety of the second embodiment, only when a certain criterion is met, the UE excludes the resources on one CC if reception of the associated PSFCH(s) overlaps with the already selected resource(s) on other CC(s).

The certain criterion can be any one of:
(1) The priority of the transmission on CC2 (i.e. the carrier on which the resource to be selected and the associated PSFCH resource is to be received) is lower than each of the priorities of all transmissions on CC1 (i.e. the carrier on which the already selected resource(s) are to be transmitted).
(2) The priority of the transmission on CC2 (i.e. the carrier on which the resource to be selected and the associated PSFCH resource is to be received) is lower than a third priority threshold, where the third priority threshold can be predetermined or configured.
(3) Each of the priorities of all transmissions on CC1 (i.e. the carrier on which the already selected resource(s) are to be transmitted) is higher than a fourth priority threshold, where the fourth priority threshold can be predetermined or configured.

Incidentally, if none of the criteria (1) to (3) is met, the resources on one CC, the reception of the associated PSFCH resource(s) of which overlaps in time domain with the already selected resource(s) on other CC(s) may not be excluded. It may be up to the implementation of the UE to decide whether the resources associated with the PSFCH resource(s) on one CC that overlap in time domain with already selected resources on other CCs are excluded from the candidate resource set for the one CC if the priority is equal to the priority threshold for criteria (2) and (3).

According to the second embodiment, the candidate resources in one CC, the PSFCH resource(s) associated with which overlap with the already selected resource(s) in another CC, are excluded from the candidate resource set for the one CC. Similar to the first embodiment, some other candidate resources may be excluded from the candidate resource set for the one CC according to other criterion or criteria. For example, some candidate resources may be excluded from the candidate resource set for the one CC in the per-carrier independent sensing procedure, or any other procedure(s). Also similar to the first embodiment, the order of excluding candidate resources from the candidate resource set for the one CC can be any order. Accordingly, according to the second embodiment, the UE selects resources for transmission in sidelink CA from the candidate resource set in which at least the overlapped resources (i.e. the PSFCH resource(s) associated with the resources overlap with the already selected resource(s)) have been excluded.

If the half-duplex issue is not considered when the resource is selected, such per-carrier independent resource selection may cause simultaneous transmission of PSSCH or PSCCH resource and reception of PSFCH resource. According to a third embodiment, when simultaneous transmission of PSSCH or PSCCH resource and reception of PSFCH resource would happen, the criterion for determining which one of transmission of PSSCH or PSCCH resource and reception of PSFCH resource is performed is specified.

According a first sub-embodiment of the third embodiment, the UE determines to perform the transmission of PSSCH or PSCCH or the reception of PSFCH based on the priority field values associated with the PSSCH or PSCCH transmissions and the sidelink transmissions associated with PSFCH. In particular, if the smallest priority field value of the sidelink transmissions associated with the PSFCH is larger than the smallest priority field value of the PSSCH or PSCCH transmissions, the UE performs the transmissions of PSSCH or PSCCH; and if the smallest priority field value of PSFCH resource(s) is smaller than the smallest field priority value of the PSSCH or PSCCH, the UE performs reception of PSFCH. Otherwise, i.e. if the smallest priority field value of sidelink transmissions associated with PSFCH is equal to the smallest priority field value of the PSSCH or PSCCH transmissions, it is up to UE implementation to determine to perform the transmission of PSSCH or PSCCH or to perform the reception of PSFCH. The field value is indicated in the SCI carried by PSCCH.

According a second sub-embodiment of the third embodiment, the UE determines to perform the transmission of PSSCH or PSCCH resource or the reception of PSFCH resource based on number of associated transmissions and the number of associated receptions. In particular, if the number of sidelink transmissions associated with the PSFCH is larger than the number of PSSCH or PSCCH transmissions, the UE performs reception of PSFCH; and if the number of sidelink transmissions associated with PSFCH is smaller than the number of PSSCH or PSCCH transmission, the UE performs transmission of PSSCH or PSCCH. Otherwise, i.e. if the number of sidelink transmissions associated with PSFCH is equal to the number of PSSCH or PSCCH transmissions, it is up to UE implementation to determine to perform the transmission of PSSCH or PSCCH or to perform the reception of PSFCH.

According to a fourth embodiment, when simultaneous transmission of PSSCH or PSCCH resource and reception of PSFCH resource happen, the UE can perform PSFCH reception and PSSCH transmission in one time occasion on different carriers. In particular, the UE may perform rate-matching or punching for the PSSCH or PSCCH resources which overlap in time domain with PSFCH resource.

For example, as shown in FIG. 4, the UE may punch the symbols in CC2 that overlap in time domain with PSFCH resources on CC1. Note that the PSFCH resources on CC1 include not only one symbol of AGC for PSFCH and one symbol of PSFCH, but also two guard symbols. Alternatively, the UE may perform rate-matching with the symbols in CC2 that overlap with PSFCH resources on CC1.

Because the RX UE has no knowledge on whether rate-matching or punching is performed on the symbols that overlap with the PSFCH resources on CC1, the TX UE may indicate whether rate-matching or punching is performed to RX UE via SCI.

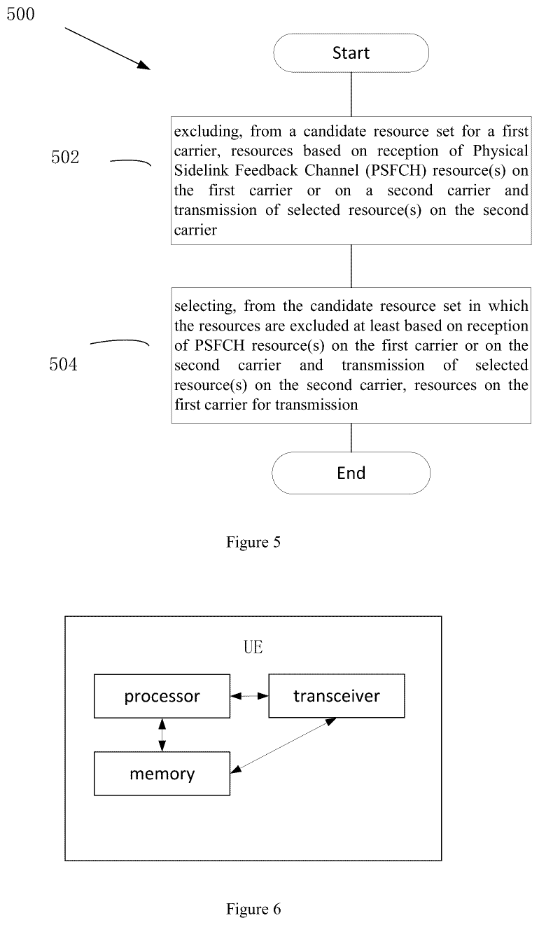

FIG. 5 is a schematic flow chart diagram illustrating an embodiment of a method 500 according to the present application. In some embodiments, the method 500 is performed by an apparatus, such as a base unit. In certain embodiments, the method 500 may be performed by a processor executing program code, for example, a microcontroller, a microprocessor, a CPU, a GPU, an auxiliary processing unit, a FPGA, or the like.

The method 500 may comprise 502 excluding, from a candidate resource set for a first carrier, resources based on reception of Physical Sidelink Feedback Channel (PSFCH) resource(s) on the first carrier or on a second carrier and transmission of selected resource(s) on the second carrier; and 504 selecting, from the candidate resource set in which the resources are excluded at least based on reception of PSFCH resource(s) on the first carrier or on the second carrier and transmission of selected resource(s) on the second carrier, resources on the first carrier for transmission.

In some embodiment, the PSFCH resource may be used for Hybrid Automatic Repeat-reQuest (HARQ) feedback or resource conflict indicator.

In one embodiment, if a resource on the first carrier overlaps in time domain with reception of the PSFCH resource associated with a selected resource on the second carrier, the resource is excluded from the candidate resource set for the first carrier. In particular, f any of the following criteria is met, the resource(s) are excluded from the candidate resource set for the first carrier if the resource on the first carrier overlaps in time domain with reception of the PSFCH resource associated with a selected resource on the second carrier: (a) the priority of the transmission on the first carrier is lower than each of the priorities of all transmissions associated with the PSFCH on the second carrier, (b) the priority of the transmission on the first carrier is lower than a first configured priority threshold, and (c) each of the priorities of all transmissions associated with the PSFCH on the second carrier is higher than a second configured priority threshold.

In another embodiment, if the PSFCH resource associated with a resource on the first carrier overlaps in time domain with a selected resource on the second carrier, the resource is excluded from the candidate resource set for the first carrier. In particular, if any of the following criteria is met, the resource(s) are excluded from the candidate resource set for the first carrier if the PSFCH resource associated with the resource on the first carrier overlaps in time domain with a selected resource on the second carrier: (a) the priority of the transmission associated with the PSFCH on the first carrier is lower than each of the priorities of all transmissions on the second carrier, (b) the priority of the transmission associated with the PSFCH on the first carrier is lower than a third configured priority threshold, and (c) each of the priorities of all transmissions associated with the PSFCH on the second carrier is higher than a fourth configured priority threshold.

FIG. 6 is a schematic block diagram illustrating apparatuses according to one embodiment.

Referring to FIG. 6, the UE (i.e. the remote unit) includes a processor, a memory, and a transceiver. The processor implements a function, a process, and/or a method which are proposed in FIG. 5.

The UE comprises a processor and a transceiver, wherein the processor is configured to exclude, from a candidate resource set for a first carrier, resources based on reception of Physical Sidelink Feedback Channel (PSFCH) resource(s) on the first carrier or on a second carrier and transmission of selected resource(s) on the second carrier; and select, from the candidate resource set in which the resources are excluded at least based on reception of PSFCH resource(s) on the first carrier or on the second carrier and transmission of selected resource(s) on the second carrier, resources on the first carrier for transmission by the transceiver.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A method performed by a user equipment (UE), the method comprising:
excluding, from a candidate resource set for a first carrier, one or more resources based at least in part on reception of at least one Physical Sidelink Feedback Channel (PSFCH) resource on the first carrier or on a second carrier, and based at least in part on transmission of one or more selected resources on the second carrier; and
selecting, from the candidate resource set for the first carrier in which the one or more resources are excluded based at least in part on reception of the at least one PSFCH resource on the first carrier or on the second carrier, and based at least in part on transmission of the one or more selected resources on the second carrier, one or more resources on the first carrier for transmission.

2. The method of claim 1, wherein, if a resource on the first carrier overlaps in time domain with reception of the at least one PSFCH resource associated with a selected resource on the second carrier, the resource is excluded from the candidate resource set for the first carrier.

3. The method of claim 1, wherein, if the at least one PSFCH resource associated with a resource on the first carrier overlaps in time domain with at least one of the one or more selected resources on the second carrier, the resource is excluded from the candidate resource set for the first carrier.

4. The method of claim 1, wherein, the at least one PSFCH resource is used for Hybrid Automatic Repeat-reQuest (HARQ) feedback or resource conflict indicator.

5. The method of claim 2, wherein, for each of the one or more resources, if any of multiple criteria is met, the resource is excluded from the candidate resource set for the first carrier if the resource on the first carrier overlaps in time domain with reception of the at least one PSFCH resource associated with the selected resource on the second carrier, wherein the multiple criteria include:
a priority of the transmission on the first carrier is lower than priorities of all transmissions associated with PSFCH on the second carrier,
the priority of the transmission on the first carrier is lower than a first configured priority threshold, and
each of the priorities of all transmissions associated with the PSFCH on the second carrier is higher than a second configured priority threshold.

6. The method of claim 3, wherein, for each of the one or more resources, if any of multiple criteria is met, the resource is excluded from the candidate resource set for the first carrier if the at least one PSFCH resource associated with the resource on the first carrier overlaps in time domain with a selected resource on the second carrier, wherein the multiple criteria include:
a priority of the transmission associated with PSFCH on the first carrier is lower than priorities of all transmissions on the second carrier,
the priority of the transmission associated with the PSFCH on the first carrier is lower than a third configured priority threshold, and
each of the priorities of all transmissions associated with the PSFCH on the second carrier is higher than a fourth configured priority threshold.

7. A user equipment (UE) for wireless communication, comprising:
at least one memory; and
at least one processor coupled with the at least one memory and configured to cause the UE to:
exclude, from a candidate resource set for a first carrier, one or more resources based at least in part on reception of at least one Physical Sidelink Feedback Channel (PSFCH) resource on the first carrier or on a second carrier, and based at least in part on transmission of one or more selected resources on the second carrier; and
select, from the candidate resource set for the first carrier in which the one or more resources are excluded based at least in part on reception of the at least one PSFCH resources on the first carrier or on the second carrier, and based at least in part on transmission of the one or more selected resources on the second carrier, one or more resources on the first carrier for transmission by the UE.

8. The UE of claim 7, wherein, if a resource on the first carrier overlaps in time domain with reception of the at least one PSFCH resource associated with a selected resource on the second carrier, the resource is excluded from the candidate resource set for the first carrier.

9. The UE of claim 7, wherein, if the at least one PSFCH resource associated with a resource on the first carrier overlaps in time domain with at least one of the one or more selected resources on the second carrier, the resource is excluded from the candidate resource set for the first carrier.

10. The UE of claim 7, wherein, the at least one PSFCH resource is used for Hybrid Automatic Repeat-reQuest (HARQ) feedback or resource conflict indicator.

11. The UE of claim 8, wherein, for each of the one or more resources, if any of multiple criteria is met, the resource is excluded from the candidate resource set for the first carrier if the resource on the first carrier overlaps in time domain with reception of the at least one PSFCH resource associated with the selected resource on the second carrier, wherein the multiple criteria include:
a priority of the transmission on the first carrier is lower than priorities of all transmissions associated with PSFCH on the second carrier,
the priority of the transmission on the first carrier is lower than a first configured priority threshold, and
each of the priorities of all transmissions associated with the PSFCH on the second carrier is higher than a second configured priority threshold.

12. The UE of claim 9, wherein, for each of the one or more resources, if any of multiple criteria is met, the resource is excluded from the candidate resource set for the first carrier if the at least one PSFCH resource associated with the resource on the first carrier overlaps in time domain with a selected resource on the second carrier, wherein the multiple criteria include:
a priority of the transmission associated with PSFCH on the first carrier is lower than priorities of all transmissions on the second carrier,
the priority of the transmission associated with the PSFCH on the first carrier is lower than a third configured priority threshold, and
each of the priorities of all transmissions associated with the PSFCH on the second carrier is higher than a fourth configured priority threshold.

13. A processor for wireless communication, comprising:
at least one controller coupled with at least one memory and configured to cause the processor to:
exclude, from a candidate resource set for a first carrier, one or more resources based at least in part on reception of at least one Physical Sidelink Feedback Channel (PSFCH) resource on the first carrier or on a second carrier, and based at least in part on transmission of one or more selected resources on the second carrier; and
select, from the candidate resource set for the first carrier in which the one or more resources are excluded based at least in part on reception of the at least one PSFCH resources on the first carrier or on the second carrier, and based at least in part on transmission of the one or more selected resources on the second carrier, one or more resources on the first carrier for transmission by the processor.

14. The processor of claim 13, wherein, if a resource on the first carrier overlaps in time domain with reception of the at least one PSFCH resource associated with a selected resource on the second carrier, the resource is excluded from the candidate resource set for the first carrier.

15. The processor of claim 13, wherein, if the at least one PSFCH resource associated with a resource on the first carrier overlaps in time domain with at least one of the one or more selected resources on the second carrier, the resource is excluded from the candidate resource set for the first carrier.

16. The processor of claim 13, wherein, the at least one PSFCH resource is used for Hybrid Automatic Repeat-reQuest (HARQ) feedback or resource conflict indicator.

17. The processor of claim 14, wherein, for each of the one or more resources, if any of multiple criteria is met, the resource is excluded from the candidate resource set for the first carrier if the resource on the first carrier overlaps in time domain with reception of the at least one PSFCH resource associated with the selected resource on the second carrier, wherein the multiple criteria include:
a priority of the transmission on the first carrier is lower than priorities of all transmissions associated with PSFCH on the second carrier,
the priority of the transmission on the first carrier is lower than a first configured priority threshold, and
each of the priorities of all transmissions associated with the PSFCH on the second carrier is higher than a second configured priority threshold.

18. The processor of claim 15, wherein, for each of the one or more resources, if any of multiple criteria is met, the resource is excluded from the candidate resource set for the first carrier if the at least one PSFCH resource associated with the resource on the first carrier overlaps in time domain with a selected resource on the second carrier, wherein the multiple criteria include:
a priority of the transmission associated with PSFCH on the first carrier is lower than priorities of all transmissions on the second carrier,
the priority of the transmission associated with the PSFCH on the first carrier is lower than a third configured priority threshold, and
each of the priorities of all transmissions associated with the PSFCH on the second carrier is higher than a fourth configured priority threshold.
